(19) United States
(12) Patent Application Publication
(10) Pub. No.: US 2004/0079250 A1
(43) Pub. Date: Apr. 29, 2004

(54) Adapter sleeve, especially for printing presses

(76) Inventors: Heinz Lorig, Legden (DE); Stephan Lorig, Legden (DE)

Correspondence Address: Fay Sharpe Fagan Minnich & McKee, 7th Floor, 1100 Superior Avenue, Cleveland, OH, 44114-2518, US

(21) Appl. No.: 10/333,896

(22) PCT Filed: Jul. 20, 2001
(86) PCT No.: PCT/EP01/08434

(30) Foreign Application Priority Data
Jul. 25, 2000 (DE) 200 12 929.5

(51) Int. Cl. B41F 13/10

(52) U.S. Cl. 101/375

(57) ABSTRACT

The invention relates to an adapter sleeve 120 for mounting or changing working sleeves carrying print forms on king rolls of printing machines, said king rolls preferably embodied as an air cylinder, drivable, and having a sheath, where the adapter sleeve 120 can be pushed axially onto the sheath of the king roll, or can be removed from it, and the body of the adapter sleeve, in the mounted state, supports the working sleeve with its outer jacket. For mounting the adapter sleeve 120, hydraulic tightening elements integrated in them serve, said tightening elements being formed on the bushing elements 121 and 122 disposed at a distance from one another and being embodied by annular elements 151, 152 disposed on the inner side of the bushing elements 121 and 122. During operation the tightening elements cause the securing against rotation between the adapter sleeve 120 and the king roll. The adapter sleeves 120 according to the invention can be used in all king rolls without changes in structure or construction having to be performed on the printing machine. On a king roll in this case, adapter sleeves 120 of arbitrary width can be used since all the means for their mounting secured against rotation are integral components.

The invention relates to an adapter sleeve for mounting or changing working sleeves bearing print forms on the king roll of printing, embossing or coating machines according to the preamble of claim 1 or 2.

In the printing industry it has been a part of the state of the art for years to operate with working sleeves, which carry the print form, or block, for the later printing process, and which are pushed onto the significantly costly king roll mounted in the printing machine. In order to make possible an easier mounting of the working sleeves and also a quick exchange of the same, the king roll is often implemented as an air cylinder in which the axial pushing on and pulling of the working sleeve takes place according to the air cushion principle. Under the action of the air cushion, the flexible sleeve is extended in the direction of its diameter so that it can be pressed on or pulled off the king roller without difficulty. On the interruption of the pressurization with compressed air the working sleeve is restored again so that it is held fixed against rotation by pressure. For example, the EP 196 443 B1 shows such a king roll/working sleeve system. At least one of the supports of the working sleeve consists of compressible material.

The number of orders and runs for individual printing orders has been diminishing. The percentage of setup costs to the total cost of the work of a printing order thus becomes enormous. In order to reduce the setup costs, the printing machine manufacturers have gone over to mounting king rolls with one end mounted in the printing machine in a fixed manner and connecting them there with the drive system. The bedding for the other end of the king roll is supported with a so-called folding bearing, which can be folded up or folded away for the change of the working sleeve. If the printing roll is embodied as an air cylinder, it is normally pressurized with compressed air at the end of the roll mounted in a fixed manner in the machine, in order to carry out the change of working sleeve utilizing the air cushion principle. Such printing machines form the preferred area of application for the invention.

Via the wall thickness of the sleeves used, the different repeating print patterns can be produced. To be sure, big wall thicknesses are desirable for sleeves, but with increasing thickness of the sleeves, however, the procurement costs for the sleeves rises and the deviations in diameter and concentricity increase. The changing over to adapter sleeves that could be inserted between the king rolls and the working sleeves took place for these reasons. An advantage in so doing is that a relatively thick-walled adapter sleeve can be made which, by means of a primarily inner-lying, compressible layer, can be pressed axially onto the king roll according to the air cushion principle. The actual working sleeve, which carries the printing form, can then be made comparably thin. In order to be able to mount the working sleeve on the adapter sleeve, the air cushion principle is again applied. In this connection, either an air supply system formed by channels is provided inside the adapter sleeve which is supplied by the compressed air connection for the king roll, or the adapter sleeve has its own compressed air connection, mostly mounted on the front side. Such a working sleeve/adapter sleeve/king roll system, with which the air connection is connected to the adapter sleeve via the compressed air connection of the king roll, is known from DE 197 53 744. To push on the working sleeve, however, a low pressure produced by means of a switchable vacuum source is used, with which the adapter sleeve is reduced in diameter for pushing open the working sleeve so that the working sleeve itself can be embodied in the essentially rigid sleeve.

An adapter sleeve according to the class is known from U.S. Pat. No. 4,794,85. The replacement and exchange of working sleeves, utilizing the air cushion principle, takes place by means of holes in the surrounding sheath of the adapter sleeve and in the bushing elements, which are connected to the compressed air system of the king roll via a hollow space in the adapter sleeve. For mounting and for securing against rotation of the adapter sleeve on the king roll the adapter sleeve is equipped with special expansion heads on its roll end journals which can be hydraulically pressurized and shifted (expanded) against the bushing element. The expansion heads are connected to one another at the opposite ends of the king roll via a hydraulic line running inside. The comparably complicated design of king rolls is disadvantageous. Furthermore, only adapter sleeves of a sleeve width as well as print width adapted to the spacing of the expansion heads can be used on a king roll.

In the printing industry the problem has long been known that limits are set for the printing quality with the working sleeve/adapter sleeve/king roll system so that certain printing qualities cannot be obtained with this design. It is the objective of the invention to provide a system with which the highest printing quality can be achieved while maintaining simple mounting or changing of working sleeve for king rolls of any design and dimensions.

This objective is achieved through the invention specified in claim 1 or in claim 2. For adapter sleeves that can be pushed axially on the sheath of the king roll, or removed from it, and whose adapter sleeve body, in the mounted position, supports the working sleeve with its outer jacket, it is proposed according to the invention that, for the mounting of the adapter sleeve, hydraulic tightening elements integrated in it are provided which during operation effect the securing against rotation between the adapter sleeve and the king roll. Therein, the adapter sleeve can have preferably at least two form-stable or incompressible bushing elements which support the body of the adapter sleeve and, with mounted adapter sleeves, are at a distance from the sheath, so that between the bushing elements, the sheath, and the body of the adapter sleeve an air chamber, preferably capable of being pressurized with excess pressure, can be formed for mounting and dismounting the working sleeve according to the air cushion principle. The adapter sleeve, which due to the essentially form-stable or incompressible bushing elements has no compressible layers and can be pressed onto the king roll without the use of the air cushion principle, provides a quasi-unyielding increase of the king roll diameter, so that even with working sleeves of large diameter no impact on printing quality occurs because of layers giving way. The mounting and fixing against rotation of the adapter sleeve itself is effected by means of the hydraulic tightening elements integrated in the adapter sleeve so that the adapter sleeve according to the invention can be used on all king rolls without having to make changes in structure or construction to the printing machine. In this connection, adapter sleeves of any width can be used on a king roll, since similar means for their rotationally fixed mounting are an integral component.

The air chamber formed between the bushing elements can furthermore be used, utilizing the air cushion principle, to push the working sleeve on the jacket of the adapter sleeve or to remove it therefrom. Since the air chamber formed between the bushing elements can cover a relatively large area of the sheath of the king roll, it is insured independently of the type of printing roller that at least one outlet opening of the compressed air system provided in the king roll leads into the chamber. The bushing elements consist preferably of metal, for example steel or aluminum, where aluminum or comparable light metals are preferred because of their lower weight.

In the particularly preferred form of embodiment, at least one of the bushing elements, preferably both bushing elements, has/have the tightening elements (means) for the rotationally fixed connection to the king roll. Through a simple development of construction, the tightening elements arranged on the inner jacket of the bushing elements can include annular elements, wherewith pressure chambers are formed between the bushing elements and annular elements which can be pressurized with hydraulic fluid. In a preferred development, the apical sides of the annular elements and of the bushing elements are then welded to one another in a manner forming a seal, where the annular elements have at least one relatively thin-walled section disposed in the area of the pressure chambers with the wall section which can arch under the pressure applied by the hydraulic fluid. With a relationship of wall thickness between the bushing elements' walls radially bounding the pressure chambers and the wall sections of the annular elements of, for example, 3:1, the pressure applied for the rotationally fixed clamping of the bushing elements on the sheath of the king roll can be transferred. In this connection, the pressure chambers of both bushing elements can be connected to one another via a connection channel in the body of the adapter sleeve, whereby the connecting channel is preferably disposed between an inside jacket and an outer jacket of the body of a double-walled adapter sleeve. This offers the advantage that the tightening elements can be implemented as a closed circuit, that is, the pressure source (hydraulic activator), the hydraulic circuit, the hydraulic tightening device, etc., are constructed within the adapter sleeve so that a closed circuit forms independently of external energy sources. The pressure in the pressure chambers for the tightening elements can expediently be generated and adjusted by one or more adjusting screw(s).

Preferably, the bushing elements form the work sleeve ends and/or the bushing elements have axially elongated, cylindrically formed bushing sections and collar sections on the end side of the roll which project radially over the bushing sections. With an adapter sleeve body formed with a double wall it is thereby made possible that the outer jacket of the body of the adapter sleeve can be supported radially on the collar sections and the inner sheath can be supported on the bushing elements in order to obtain an adapter sleeve body resistant to bending and supported on a large area. The resistance to bending can be further increased if the intermediate space between the inside sheath and the outside sheath is filled with a preferably incompressible material of low density, in particular polyurethane. In so doing, the filling provides, in particular midway between the bushing elements, for a high rigidity and precision of concentricity of the adapter sleeve. A particularly simple design is achieved if the inner jacket and/or outer jacket are formed of tubes of composite material, in particular of fiber-reinforced plastic material. This immediately reduces the weight of the adapter sleeve. However, the outer jacket in particular can also be formed of an aluminum or light metal tube so that the body of the adapter sleeve has high rigidity with low weight and is quasi-incompressible and/or undeformable.

In the preferred development the bushing elements, or the annular element disposed thereon, which is adapted essentially with precise fit with adaptation of play to the outer diameter of the sheath of the king roll so that the adapter sleeve can be pushed on the king roll without auxiliary means. After pressurizing the pressure chambers the air chamber is then automatically completely sealed. Furthermore, one of the bushing elements can be provided preferably with one or more through-channels which lead from the air chamber to the outer jacket so that the compressed air system of the king roll can be utilized, via the through-channels, for mounting and dismounting the working sleeve. Through-channels of this type can be cost-effectively formed in the bushing parts by holes. Since the pushing of the working sleeve on the adapter sleeve is done from that end of the adapter sleeve on whose side the folding bearing or the like of the printing machine is provided, it is obvious that preferably the bushing part with the through-channels is also provided on this side of the adapter sleeve.

Alternatively, at least one of the bushing elements can be provided with several axial and radial holes which can be supplied via a common compressed air connection where preferably the radial holes are formed in the collar section and are connected via the axial holes to an annular chamber which is formed between the apical face of the collar spacer and the annular face of the outer spacer of the bushing element by means of an additional angled profiled ring or the like preferably welded on in a manner forming a seal. The annular chamber can then also be connected to a compressed air supply connection on the opposite bushing element via a connecting tube penetrating the double-walled body of the adapter sleeve in the interior, in case the adapter sleeves of king rolls are used which are not implemented as an air cylinder. Alternatively, the axial holes can also be through-holes and connected to its own compressed air supply on the spherical end side of the folding bearing. Furthermore, at least one of the bushing elements can have means on the adapter sleeve for securing the working sleeve against rotation or can be provided with a recess for a corresponding fitting pin or the like.

On the whole the invention provides an adapter sleeve in a hybrid mode of construction with very light total weight which can support a working sleeve independently of the design of the king roll and can be used in nearly all printing machines. The adapter sleeve with the previously described design without compressible layers can also be used when no working sleeve is supported with it but rather the adapter sleeve carries a print form (print plate) on its outer jacket or is provided with a print form (print layer) directly. In the form of embodiment with printing layer it is preferred if the print layer is formed by one or more layers of rubber, photopolymer, silicone polymer, silicone fluoropolymer, or the like. Furthermore, the adapter sleeve's design according to the invention without compressible layers also offers particular advantages if the adapter sleeve, instead of supporting a working sleeve with print form, forms with its metallic outer jacket the base sleeve of a screen roll sleeve. To form a screen roll sleeve the outer jacket of the adapter sleeve can be coated with a ceramics such as chromium oxide and the chromium oxide layer or ceramics layer is laser-engraved. Since screen roll sleeve normally are not mounted on axes of the printing machine which are equipped with an air cylinder, it is obvious that in the form of embodiment of the adapter sleeve as screen roll sleeve, any channel system can be omitted in the mounting bushings.

Additional advantages and developments of the invention follow from the subordinate claims and the following description of preferred embodiment examples shown in the drawings. Shown in the drawings are:

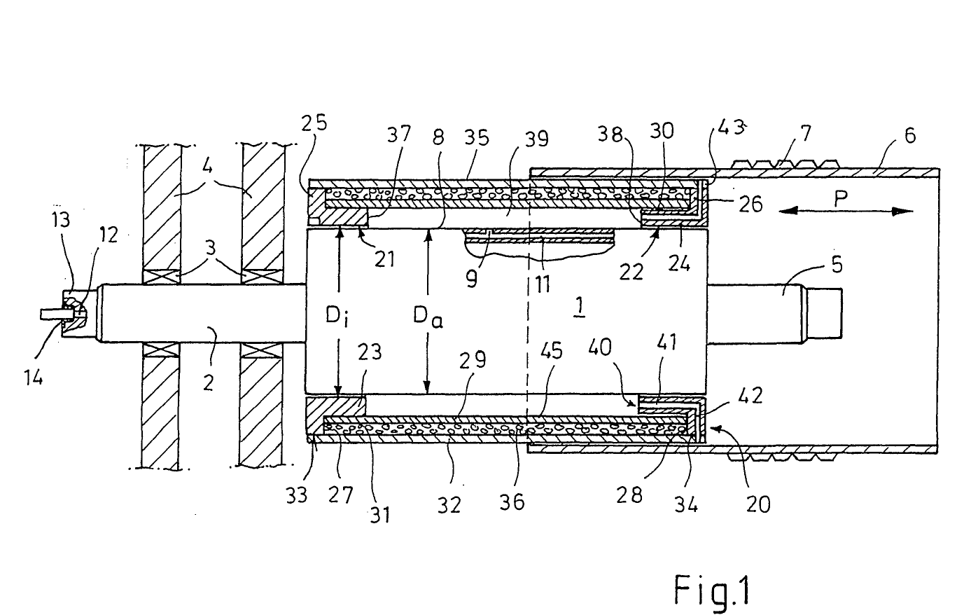

FIG. 1 in schematic representation, partially in section, a king roll and an adapter sleeve having features according to the invention with working sleeve not completely pushed on,

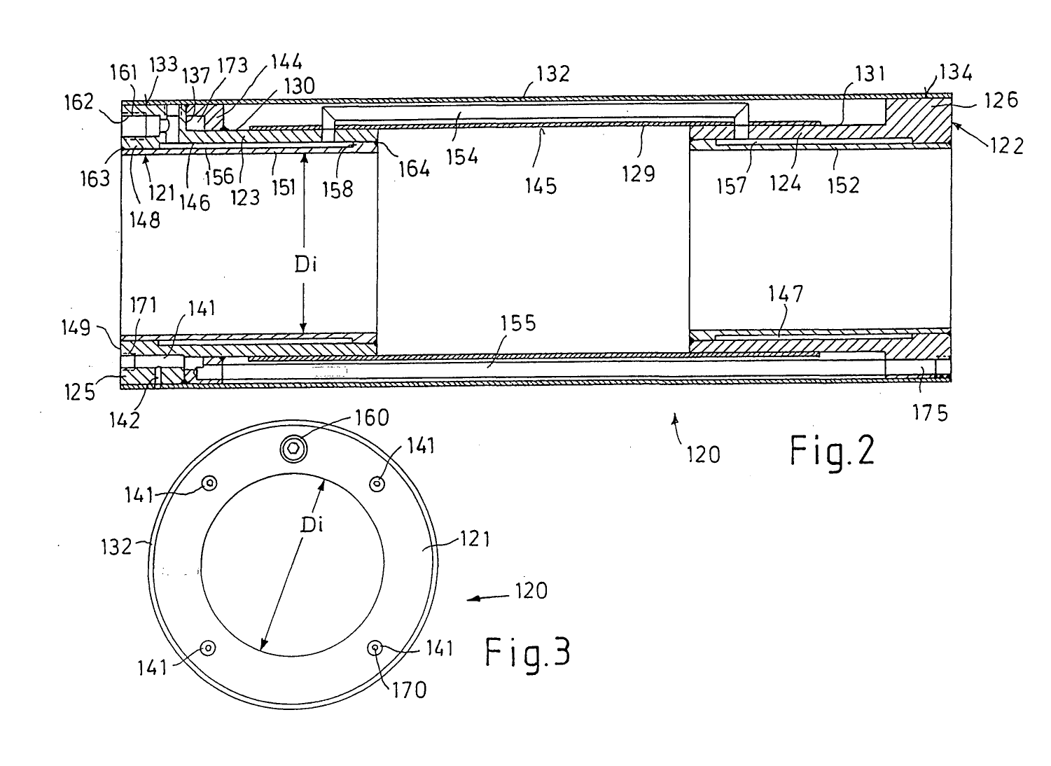

FIG. 2 a longitudinal section through an adapter sleeve formed according to the invention, and

FIG. 3 a side view of the spherical left, in FIG. 2, end of the adapter sleeve.

In the highly simplified and not-to-scale representation in FIG. 1, a king roll, formed here as an air cylinder, is denoted by 1, said king roll, with its left, in FIG. 2, roll bearing journal 2, being rotatably mounted, by means of a double bearing 3, in a roll stand 4 of a printing machine not represented in more detail in such a manner that the king roll 1 does not have to be removed for mounting or changing working sleeves. The king roll 1 thus projects, as shown in FIG. 1, freely out to the side when the supporting bearing associated with the other bearing journal 5 of the king roll 1, and not represented, is removed. As is known, the removable support part preferably consists of a so-called folding bearing.

In the figure a working sleeve 6 with a print form 7 indicated on the circumference is represented where said working sleeve can be pushed onto the king roll 1 from the side of the bearing journal 5 with the folding bearing removed. The working sleeve 6 can be a glass-reinforced plastic tube with hard coat surface or soft coat surface which carries a print form 7, a print block, an embossing form or the like, if needed or desired, fastened with a tape. The fiber-reinforced or glass-reinforced plastic tube leads to a comparatively high rigidity of the working sleeve but allows minimal extensions so that the working sleeve 6 can be changed utilizing the air cushion principle.

The working sleeve 6 is not supported directly on the king roll 1 but rather, between the sheath 8 of the king roll 1 and the working sleeve 6, an adapter sleeve 6 denoted by 20 is mounted. The adapter sleeve 20 has two metal bushings 21, 22, for example made of steel or aluminum, which are neither deformable nor compressible. The two metal bushings 21, 22 form the adapter sleeve ends of the adapter sleeve 20. The inner diameter Dᵢ of the metal bushings 21, 22 is adapted to the outer diameter Dₐ of the sheath 8 for a precise fit so that the metal bushings 21, 22 can be pushed over the sheath 8 of the king roll 1 with little play without the air system of the king roll 1 being used. For subsequent fastening against rotation between the king roll 1 and the adapter sleeve 20, tightening elements, which are hydraulic, integrated into the adapter sleeve, and not represented in FIG. 1, are used, which are explained further in the following with reference to FIG. 2. Each of the metal bushings 21, 22 has an annular bushing section 23, 24 extending axially and a collar section 25, 26 formed on the end side of the roll and projecting radially over the bushing section 23, 24. Between the apical faces 27, 28 of the collar spacer a fiber-reinforced plastic tube 29 extends which with the collar width of the collar sections 25, 26 determines the length of the adapter sleeve 20. The plastic tube 29 is supported on the outer annular faces 30, 31 of the bushing section 23, 24 and is preferably connected to it so as to be fixed against rotation. A second tube 32 of fiber-reinforced plastic, aluminum, or another bending-resistant material is supported on the outer collar sections 33, 34 of the collar sections 25, 26 of the bushing elements 21, 22 and is preferably connected to it in a rotationally fixed manner. The tube 32 has a greater length than the tube 29 and extends over the entire length of the adapter sleeve 20. The outer side of the tube 32 forms the outer jacket 24 of the adapter sleeve 20 while the bare inner face of the tube 29 forms the inner jacket 45 of the adapter sleeve 20. The intermediate space 36 between the tubes 29, 32, which are highly resistant to bending, is, as indicated schematically, filled with polyurethane or another material which is incompressible and has low-density so that with the overall low intrinsic weight of the adapter sleeve 20 bending of the body of the adapter sleeve formed by the tubes 29 and 32 is structurally ruled out.

In the adapter sleeve 20 mounted on the king roll 1, as shown in the figure, an air chamber 39 arises between the sheath 8 of the king roll 1, the bare inner jacket 35 of the body of the supporting sleeve, and the inner apical end faces 37, 38 of the bushing elements 21, 22. The air chamber 39 extends over nearly the entire width of the king roll 1. The king roll 1 formed as an air cylinder has a system of air lines with several radial outlet openings of which in the figure only one outlet opening 9, lying relatively in the middle, is shown. This outlet opening 9 is connected via a channel system 11 with an inlet line 12 which empties into the end journal 13 of the bearing journal 2 mounted in a fixed manner but rotatably in the printing machine. In the end journal 13 an indentation is formed on its apical side in which a compressed air connection 14 with rotary transmission leadthrough is mounted. A source of compressed air not shown can supply compressed air to the air chamber 39 via the line of the compressed air connection 14, the inlet line 12, the channel system 11, and the outlet opening 9. So that compressed air can be used in the air chamber 39 during mounting or dismounting of the working sleeve 6, as indicated with the arrow P and the only half pushed-on working sleeve 6, the metal bushing 22 on the folding bearing side has one or more through-channels 40 which are formed by axial holes 41 and radial holes 42. For example, four through-channels 40 disposed offset by 90° with respect to one another can be provided. The radial hole 42 formed in the collar section 26 of the metal bushing 22 and emptying into the collar's outer face 34 works together with radial through-passages 43 in the outer tube 32. Thereby an air cushion can be produced for the working sleeve 6 on the push-on side by means of the compressed air supplied via the air chamber 39, said air cushion expanding in such a manner that, as already known, the working sleeve 6 can be pushed onto the adapter sleeve 20. Fitting pins can project out over the collar's outer face 33 which cause an additional restraint against rotation between the working sleeve 6 and the adapter sleeve 20. Since, due to its double-walled construction and its support on the form-stable metal bushings 21, 22, the body of the adapter sleeve is resistant to bending, printing is possible with the adapter sleeve 20 according to the invention with nearly any working sleeve diameter. With this, the highest printing quality can be achieved since there are no flexible layers in the hybrid adapter sleeve. The adapter sleeve 20 can work together with nearly all air supply systems for the king roll 1, since the relatively large air chamber 39 includes at least one outlet opening of the air supply system in the king roll.

FIGS. 2 and 3 show, in an embodiment example, an adapter sleeve 120 in a sectional view and side view with the tightening elements according to the invention and formed by bushing elements 121 and 122 disposed at a distance from one another, said tightening elements having the form of annular elements 151,152 disposed on the inner side of the bushing elements 121 and 122, the design and mode of action of said tightening elements still to be explained. Each of the bushing elements 121 and 122 have, as in the embodiment example according to FIG. 1, a collar section 125, 126 formed as a radial spacer as well as an axially extending bushing section 123, 124 whose outer annular face 130 or 131 forms a supporting face for the inner jacket 145 of an inner tube 129, highly resistant too bending, while a second outer tube 132 is supported on the outer collar faces 133, 134 of the collar sections 125, 126. The intermediate space between the two tubes 129, 132 is preferably filled with an incompressible material having a low density, such as, for example, polyurethane, in order to guarantee the resistance to bending of the adapter sleeve 120.

The inner space formed between the tubes 129, 132 furthermore has in addition a connecting channel 154 for hydraulic fluid as well as a connecting tube 155 for a separate air system in the adapter sleeve 120. The connecting tube 155 and connecting channel 154 are disposed offset by 180° with respect to one another and imbedded in the filling of the body of the adapter sleeve in order not to affect the precision of concentricity of the adapter sleeve 120. Two pressure chambers 156, 157, which are formed between the axially extending wall sections of the annular elements 151, 152 and the set-back inner sides 146, 147 of the bushing sections 123, 124, are connected by the connecting channel 154. In the embodiment example shown the annular elements 151, 152, as well as the bushing elements 121, 122 consist of rotary parts with a radially projecting annular spacer 148 or 158 so that the pressure chambers 156, 157 are formed as hollow spaces with the annular elements 151, 152 during the assembly of the bushing elements 121, 122. The wall sections of the annular elements 151, 152 have in this case a clearly smaller cross-section than the wall of the bushing sections 123, 124 so that on hydraulic pressurization of the pressure chambers 156, 157, the wall sections of the annular elements 151, 152 arch spherically into the inner space of the adapter sleeve 120 and through the arching achieve a rotationally fixed connection with the sheath 8 of the king roll 1 (FIG. 1). An adjustable, variable pressure of the hydraulic fluid in the pressure chambers 156, 157 can be achieved by means of an adjusting screw 160 (FIG. 3) which is screwed in or screwed out, to various depths, in a storage chamber 161 connected to the hydraulic system (pressure chamber 156, 157 and connecting channel 154). The adjusting screw 160 is in this case screwed into an inner thread 162 of the storage chamber 161 embodied as a hole. In a closed hydraulic system even slight adjustment movements of the adjusting screw 160 are sufficient to obtain the necessary contact force for the wall sections of the annular elements 151, 152 on the sheath 8 of the king roll 1 for securing against rotation or to reduce the pressure in case the adapter sleeve 120 is supposed to be dismounted. The contact face of the annular spacer 148 with the annular element 151 and that of the annular spacer 158 of the annular element 151 [sic] with the bushing section 123 are welded to one another, as represented in the left bushing element 121 in FIG. 2. The annularly encircling weld seams 163, 164 provide at the same time for a sealing of the pressure chamber 156 so that additional sealing rings or sealing means, if needed or desired, can be omitted. Furthermore, the middle wall section of the annular elements 151 can, due to the welding of the outer areas of the annular elements 151, definitely arch inwards.

The adapter sleeve 120 shown in FIGS. 2 and 3 is furthermore provided with its own system of air lines which can be used independently of a compressed air system provided in the king roll. The bushing elements 121 on the folding bearing side, on the left in FIG. 2, has for this purpose an axial through-hole 141 in the collar section into which each of the radial holes 142 passing through the collar section 125 and the outer tube 132 empty. As FIG. 3 shows there are in all four axial holes 141, each offset by 180° with respect to one another and distributed over the circumference, where the axial holes 141 are offset in addition by 45° to the hole, housing the storage chamber 161 and the adjusting screw 160, for the hydraulic system. In the embodiment example shown according to FIG. 2 the respective axial holes 141 are plugged by means of suitable screw plugs 170 which are screwed into corresponding threaded sections 171 on the outer folding bearing-side spherical end 149 of the adapter sleeve 120. All four axial holes 141 empty into an annular chamber 173 which is formed on the bushing element 121 by means of an annular spacer element 174 welded on the apical end face 137 of the collar section 125 and on the outer annular face 130 of the bushing section 123. The encircling annular chamber 173 is connected via the connecting tube 155 to a compressed air supply connection 175 on the other bushing element 122 so that an external compressed air line can also be connected to the opposite bushing element 122 in order to cause the pushing on of the working sleeve not shown here according to the air cushion principle. It is understood that alternatively the compressed air connection 175 can be plugged with a screw plug and instead of this the compressed air line on one of the axial holes 141 is connected or the compressed air system of the king roll, as embodied with reference to FIG. 1, is used.

For those skilled in the art a series of modifications follows which should fall in the protected area of the invention. For additional weight reduction the metal bushing could be provided with additional hollow spaces or the like. The axial length of the metal bushing can be varied so long as a sufficiently bending-resistant support of the body of the adapter sleeve results. In particular for very great lengths of the king roll or adapter sleeve additional, in particular metallic supporting rings can be formed between the bushing elements so that, if needed or desired, several air chambers result. Furthermore, the metal bushings could also be connected to one another by intermediate spacers. Adapter sleeves which do not serve to support adapter sleeves, but rather are provided themselves on their outer jacket with a printing plate or a printing coating, should fall in the protected area. Furthermore, the adapter sleeve can also be used on other axes in the printing machines, for example, as screen roll sleeve on the inking axes.

1. Adapter sleeve for mounting or changing working sleeves carrying print forms on king rolls of printing machines, said king rolls preferably embodied as an air cylinder, drivable, and having a sheath, where the adapter sleeve can be pushed axially onto the sheath of the king roll, or can be removed from it, and the body of the adapter sleeve, in the mounted state, supports the working sleeve with its outer jacket, having at least two form-stable or incompressible bushing elements disposed at a distance from one another which support the body of the adapter sleeve and with the adapter sleeve mounted are at a distance from the sheath in such a manner that between the bushing elements, the sheath, and the body of the adapter sleeve an air chamber preferably pressurized with excess pressure is formed, characterized by the fact that, for mounting the adapter sleeve (20, 120), hydraulic tightening elements integrated in them are provided, said tightening elements causing, during operation, the securing against rotation between the adapter sleeve (20, 120) and the king roll (1).

2. Adapter sleeve for mounting or changing working sleeves carrying print forms on king rolls of printing machines, said king rolls preferably embodied as an air cylinder, drivable, and having a sheath, where the adapter sleeve can be pushed axially onto the sheath of the king roll, or can be removed from it, and the body of the adapter sleeve, in the mounted state, supports the working sleeve, characterized by the fact that, for mounting the adapter sleeve (20, 120), hydraulic tightening elements integrated in them are provided, said tightening elements causing, during operation, the securing against rotation between the adapter sleeve (20, 120) and the king roll (1).

3. Adapter sleeve according to claim 2, characterized by two essentially form-stable bushing elements (21, 22; 121, 122) disposed at a distance from one another and supporting the body of the adapter sleeve which, with the adapter sleeve (20; 120) mounted, are at a distance from the sheath of the body (29, 32; 129, 132) of the adapter sleeve.

4. Adapter sleeve according to one of the claims 1 to 3, characterized by the fact that the bushing elements (21, 22; 121, 122) are made of metal, in particular, steel or a light metal, such as aluminum.

5. Adapter sleeve according to one of the claims 1 to 4, characterized by the fact that least one of the bushing elements (21) has the tightening elements for securing against rotation between the adapter sleeve (20) and the king roll (1).

6. Adapter sleeve according to one of the claims 1 to 5, characterized by the fact that the tightening elements include annular elements (151, 152) disposed on the inner jacket of the bushing elements (121, 122) where pressure chambers (156, 157) are formed between the bushing elements (121, 122) and the annular elements (151, 152), said pressure chambers being pressurizable with hydraulic fluid.

7. Adapter sleeve according to claim 6, characterized by the fact that apical sides of the annular elements (151) and the bushing elements (121) are welded to one another in the manner forming a seal where the annular elements (151) have at least one relatively thin-walled wall section which is disposed in the area of the pressure chamber (156) and can arch due to the pressure applied by hydraulic fluid.

8. Adapter sleeve according to claim 6 or 7, characterized by the fact that the pressure chambers (156, 157) of both bushing elements (121, 122) are connected to one another by the connecting channel (154) in the body of the adapter sleeve where the connecting channel (154) preferably is disposed between an inner jacket (129) and an outer jacket (132) of a double-walled body of an adapter sleeve.

9. Adapter sleeve according to one of the claims 1 to 8, characterized by the fact that the tightening elements are embodied as a closed circuit where preferably the pressure can be generated and changed in the pressure chambers (156, 157) for the tightening elements with one or more adjusting screw(s) (160).

10. Adapter sleeve according to one of the claims 1 to 9, characterized by the fact that bushing elements (21, 22; 121, 122) form the adapter sleeve ends and/or have axially extending bushing sections (23, 24; 123, 124) and collar sections (25, 26; 125, 126) on the adapter sleeve side which project radially over the bushing sections (23, 24; 123, 124).

11. Adapter sleeve according to one of the claims 1 to 10, characterized by the fact that the body (29, 32; 129, 132) of the adapter sleeve is double-walled and preferably has an outer jacket (32, 132) being supported radially on the collar sections (25, 26; 125, 126) and an inner jacket (29; 129) being supported n the collar sections (23, 24) where furthermore preferably the intermediate space (36) between the inner jacket (29; 129) and the outer jacket (32; 132) is filled with a material which is essentially incompressible and has low-density, in particular polyurethane, to achieve a high rigidity and a quasi-incompressible and/or undeformable body of the adapter sleeve.

12. Adapter sleeve according to claim 8 or 11, characterized by the fact that the inner jacket (29; 129) and/or the outer jacket (32; 132) is/are formed of tubes of composite material, in particular of fiber-reinforced plastic material, or an aluminum tube or light metal tube forms the outer jacket (32; 132).

13. Adapter sleeve according to one of the claims 1 to 12, characterized by the fact that the bushing elements (21, 22, 121, 122) or the annular elements (151, 152) disposed on them have an inner diameter (Dᵢ) which is essentially precisely adapted to the outer diameter (Dₐ) of the sheath (8) of the king roll (1).

14. Adapter sleeve according to one of the claims 1 to 13, characterized by the fact that the bushing element (22) is provided with one or more through-channels (40) which lead from the air chamber (39) to the outer jacket (35) of the tube (32) where preferably the through-channels (40) are formed by axial holes (41) in the bushing section (24) and by radial holes (42) in the collar section (26).

15. Adapter sleeve according to claim 14, characterized by the fact that the bushing element (22) provided through-channels (40) forms that end of the adapter sleeve on which a folding bearing or the like of the printing machine can be mounted on the king roll (1).

16. Adapter sleeve according to one of the claims 1 to 13, characterized by the fact that at least one of the bushing elements (121) is provided with several axial and radial holes (141; 142) distributed over the circumference which can be supplied via a common compressed air connection where preferably the radial holes (142) are formed in the collar section (125) and are connected via the axial holes (141) to an annular chamber (173) which is formed between the apical face (137) of the collar spacer and the annular face of the outer spacer (130) of the bushing element (121) by means of an additional angled profiled ring (174) preferably welded on in a manner forming a seal.

17. Adapter sleeve according to claim 16, characterized by the fact that the annular chamber (173) is connected to a compressed air supply connection (175) on the opposite bushing element (122) via a connecting tube (155) penetrating the double-walled body of the adapter sleeve in the interior.

18. Adapter sleeve according to claim 16, characterized by the fact that the axial holes (141) are through-holes and can be connected on the end side of the adapter sleeve to the compressed air supply.

19. Adapter sleeve according to one of the claims 1 to 18, characterized by the fact that at least one of the bushing elements (121) has means to secure against rotation between the working sleeve (6) and the adapter sleeve (20).

20. Adapter sleeve according to one of the claims 1 to 19, characterized by the fact that the adapter sleeve does not support a working sleeve but rather carries a print form (print plate) or is provided directly to a print form (print layer) where preferably the print layer is formed by one or more layers of rubber, photopolymer, silicone, silicone polymer, silicone fluoropolymer, or the like.

21. Adapter sleeve according to one of the claims 1 to 20, characterized by the fact that the adapter sleeve does not support a working sleeve with print form but rather forms with its metallic outer jacket the base sleeve for a screen roll sleeve where preferably the outer jacket is coated with chromium oxide and the chromium oxide layer (ceramic layer) is laser-engraved.
